(19) United States
(12) Patent Application Publication
(10) Pub. No.: US 2026/0144695 A1
(43) Pub. Date: May 28, 2026

(54) KNITTED GRIP STRENGTHENING GLOVE

(71) Applicant: BIOSERVO AB, Kista (SE)

(72) Inventor: Emma Helena LINDER, Uppsala (SE)

(21) Appl. No.: 19/123,289

(22) PCT Filed: Oct. 31, 2023
(86) PCT No.: PCT/EP2023/080408

§ 371 Date: Apr. 22, 2025

(30) Foreign Application Priority Data
Oct. 31, 2022 (SE) 2251272-7

(51) Int. Cl. A61H 1/02

(52) U.S. Cl. CPC A61H 1/0285

(57) ABSTRACT

Knitted grip strengthening glove (1) comprising a hand portion (2) having a palm side (3) and a dorsal side (4), and at least one finger portion (5), the glove is knitted into a stretchable material, at least one artificial tendon (6) is arranged at the outside or within the knitted material, the finger portion is knitted so that at least one fingertip (7) has limited stretch, the finger portion is knitted so that it comprises at least one reinforced area with limited stretch in a direction crosswise the length direction of the finger portion on the dorsal side of the glove, while the palm side of the finger portion and the glove are a knitted structure that are flexible in at least two directions, the reinforced areas reach down on each side of the finger portion creating reinforced side portions, wherein the at least one artificial tendon is slidably attached at the reinforced side portions.

The present invention concerns a knitted grip strengthening glove made of a stretchable material

### BACKGROUND

Existing grip strengthening gloves on the market are made of a textile that is cut into pieces and sewn together to form a glove. Often such grip strengthening gloves are made to be used with a protective glove on top. Cut and sewn gloves always include seams that can be uncomfortable for the wearer. The seams do not stretch and for comfort reasons, the seam allowances need to be turned outwards, away from the wearer's hand. Another problem with cut and sewn gloves is integration of force transferring and electric components such as pressure sensors and cables. This has for example been solved by using textile layering, which is described in WO 2017/207507. Using several layers can however have a drawback in that it gives the wearer less freedom of movement and the gloves are also warm to work in. Other drawbacks are a restriction in tactile feedback from objects interacted with the hand which makes the manipulation of small objects such as bolts difficult.

The current glove production is labour intensive. The peculiarity and quality requirements of grip strengthening gloves call for a careful one-to-one training of dedicated sewing labour. This training needs to be repeated every time there are changes made to the glove design. Manual sewing skills or crafts knowledge of individual operators determine the outcome. This means that there is a variation among glove textiles produced within one single batch. The functionality of the gloves leaves little margin for errors. The efficient force transfer to the fingers depends on millimetre tolerances. Current cut-and-sewn production give a 2 mm tolerance on sewing operation. Even 1 mm error may cause glove fingers to twist during activation of the artificial tendons. Twisted fingers are not only uncomfortable but may also displace sensors from their predefined positions and cause un-balanced force distribution.

In gloves where several layers are used, there could also be problems with internal sliding if layers which cause malfunction and an unsecure gripping experience to the wearer.

There is hence a need for a glove which has less layers in the glove, which preferably integrates sensors, communication, wiring and force transferring function in as few layers as possible.

WO2019010520 and WO 2021087557 show seamless, knitted grip strengthening gloves comprising reinforced zonal bands. The reinforced zonal bands encircles the finger and hand. These bands add a dullness to which the force from the tendons can be attached and thus strengthen the grip. This type of glove is advantageous because of the fast production, which will provide a glove to a low manufacturing cost. There are however several drawbacks with gloves produced in this way. One of the problems with gloves knitted in this way being that since bands are knitted around the entire circumference of the finger or part of the hand provided with zonal bands, it will be hard to provide a good fit of the glove to all the variations in hand proportions within one size. Individuals with wider or narrow fingers that use the same glove size will experience that the glove fingers as too tight or too large at the zonal bands. Glove fingers that do not sit tight enough around the wearer's finger risk moving relative to the finger, which does not ensure correct control of a grip strengthening glove. Another problem is that it is difficult to get a good connection between the fingers and the wrist for force handling. A glove knitted with bands will further be more limited in possibilities to add layers such as pockets and channels to integrate cable, tendons and sensors.

Other examples of gloves using knitted material is WO 2015134336 and US 2021301432.

The present invention solves the problems mentioned above and provides a grip strengthening glove that is knitted into a flexible and mostly stretchable material which ensures a good fit of the glove while still being flexible enough to give a comfortable glove for the wearer.

### SUMMARY OF THE INVENTION

The present invention provides a knitted grip strengthening glove According to a first aspect of the invention, a knitted grip strengthening glove comprising a hand portion having a palm side and a dorsal side, and at least one finger portion. The knitted grip strengthening glove is knitted into a stretchable material in order to at least suit different proportions of one size of hands, and possibly up to two sizes. At least one artificial tendon is arranged at the outside of the knitted finger glove, and at least one finger portion is knitted so that the fingertip of the glove has limited stretch. The at least one finger portion is knitted so that it comprises at least one area with limited stretch in a direction crosswise along the length direction of the finger portion on the dorsal side of the finger portion, while the palm side of the glove is made of a of a flexible material having a knitted structure that are flexible in at least two directions.

According to one embodiment the limited stretch is a stretch limited in the material itself.

According to one embodiment the at least one finger portion comprises at least one knitted channel in order to be able to bring a cable up along the finger and attach to a sensor provided at the fingertip.

According to one embodiment the at least one finger portion comprises conductive threads leading up to a sensor provided at the fingertip.

According to one embodiment the dorsal side of the hand portion comprises lengthwise areas extending from a wrist portion up to the at least one finger portion, which lengthwise areas has limited stretch in the length direction.

According to one embodiment the wrist portion is provided with at least one opening in order to be able to attach a force anchoring device inside wrist portion.

According to one embodiment the at least one finger portion is provided with at least two areas having limited stretch in a direction crosswise the length direction of the finger portion on the top side of the finger portion.

According to one embodiment threads providing cutting protection or threads providing fire protection are knitted into the glove.

According to a second aspect of the invention, a glove comprising a knitted grip strengthening glove as a liner according to any of the embodiments above is provided.

### SHORT DESCRIPTION OF THE DRAWINGS

The present invention will now be described in more detail and under referral to the attached drawings, in which:

FIG. 1A and B show an embodiment of a palm side and a dorsal side, respectively, of a knitted grip strengthening glove with areas having limited stretch.

FIG. 2 shows an embodiment of a palm side of a knitted grip strengthening glove

FIG. 3 shows an embodiment of a dorsal side of a knitted grip strengthening glove

FIG. 4 shows another embodiment of a palm side of a knitted grip strengthening glove

FIG. 5 shows another embodiment of a dorsal side of a knitted grip strengthening glove

FIG. 6 shows another embedment of a dorsal side of a knitted grip strengthening glove

FIG. 7 shows a schematic build-up of a knitted pressure sensor

FIG. 8A and B show an embodiment of a palm side and a dorsal side, respectively, of a knitted glove comprising knitted portions comprising conductive threads and knitted pressure sensors

FIG. 9 shows an enlarged detail of the embodiment in FIG. 8a.

### DETAILED DESCRIPTION OF EMBODIMENTS

Stretchable material in this application is a material which can be stretch in its plane and return to its initial shape. A flexible material can flex out of the plane.

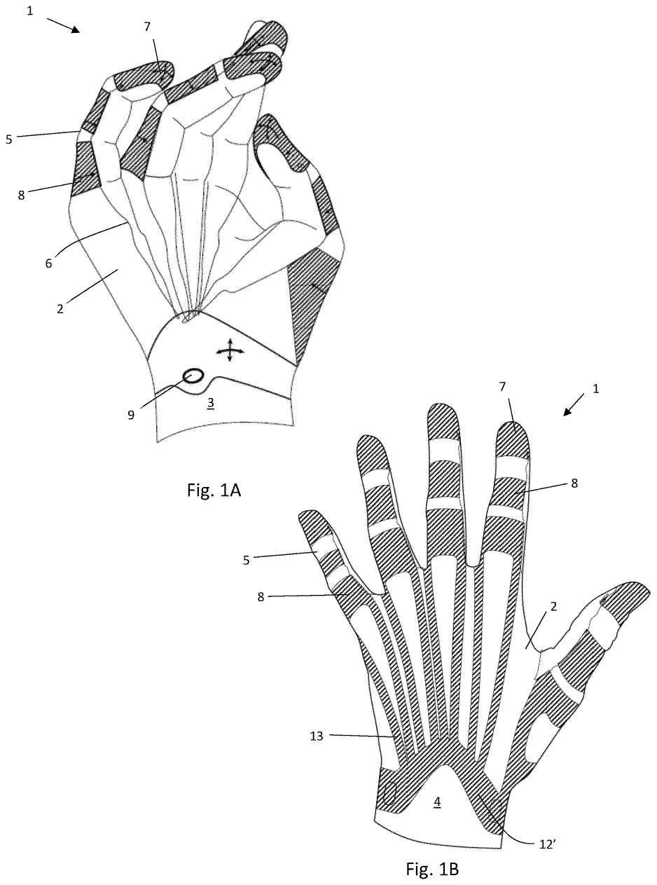

In FIG. 1 a first embodiment of a palm side 3 of a knitted grip strengthening glove 1 is shown. The glove 1 comprises a hand portion 2 and at least one finger portion 5 having a fingertip 7. The finger portion 5 may be suitable for any of the fingers of a wearer's hand including the thumb. The grip strengthening glove is provided with areas 8 having limited stretch.

The grip strengthening glove according to the present invention is made of a stretchable material. The stretchable material is knitted in order to provide the stretchability. Thus, one size of a glove 1 suits different sizes of hands, both length and wide wise. For example one size of a glove can preferably fit up to two sizes of hands. Areas having limited stretch is in this embodiment are shown as broken lines.

The stretchable material has different stretch requirements depending on which part of the glove it is used for. This is possible to achieve since the glove 1 is knitted to give specific stretch in different areas as described further below.

Knitting is a technique where two or more needles are used to loop yarn into a series of interconnected loops in order to create a finished garment or some other type of fabric.

There are multiple options to obtain the desired characteristics of the knitted glove, including but not limited to Intarsia knitting, plating knitting and inlay knitting. Also knitting with heat-activated yarns is possible.

Intarsia knitting is a knitting technique where more than one yarn is used and allows a change of properties, initially used for creating colour blocks, in this case used to create areas having different stretch in the middle of a row without having floats across the back of the knitting.

Plating knitting is techniques of simultaneous knitting with two or more yarns differing in colour, material, properties etc. to produce some special effect on the fabric surface. A plated structure contains loops composed of two or more yarns, often with different physical properties. The fabrics are formed by using different kinds of yarn types or colours to be invisible on the other side. Different properties of several textile fibres are exploited to obtain various surface interests and patterns.

Inlay knitting is a technique using two yarns, where one yarn is used for the knitting and the second is moved between the stitches front and back to create a different physical property of the fabric. The second yarn may then be a passive yarn, at least in parts of the knitting process, so that different parts of the knitted structure is provided with different properties.

A heat activated yarn is a synthetic yarn with heat-activated binder fibres. The product is knitted with the synthetic yarn comprising heat-activated binder fibres, and the product (or a part of the product) is thereafter heated so that the binder fibre melts sufficiently so that it is capable of flowing out and attach to the surrounding yarns. The yarn is then cooled to solidify the melted binder fibre and thus creates an area having limited stretch/flexibility.

The function of a grip strengthening glove however requires a mix of areas made of a stretchable material and areas having limited stretch. Both the stretchability and recovery of the fabric is of importance. The stretchable material in the glove is knitted so that different areas have different stretch. The stretchable areas of the grip strengthening glove according to the present invention is a knitted structure that is stretchable in at least two directions, preferably in any direction. It allows for prolongation and recovery both width-and lengthwise. Other areas of the glove are knitted so that they have limited stretch in at least one direction. Some of the areas of the glove can be knitted so that the stretch is limited in at least two directions.

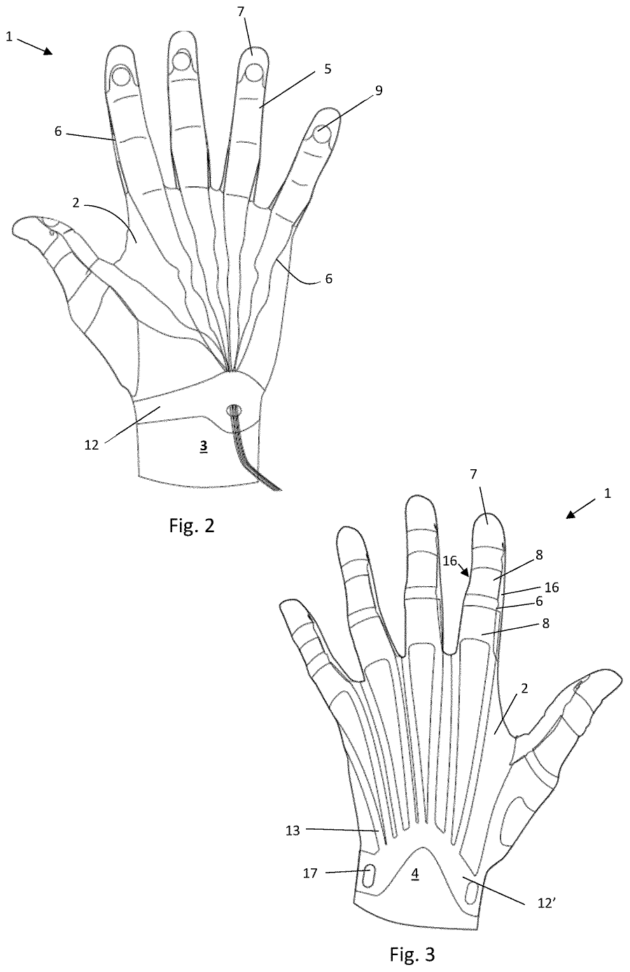

In FIG. 2 an embodiment of of a palm side 3 of a knitted grip strengthening glove 1 is shown. The glove 1 comprises a hand portion 2 and at least one finger portion 5 having a fingertip 7. The fingertips have been provided with sensors 9 (described further below) and each finger have been provided with two artificial tendons 6 (described further with reference to FIG. 3 below). The knitted grip strengthening glove is also provided with a wrist portion 12.

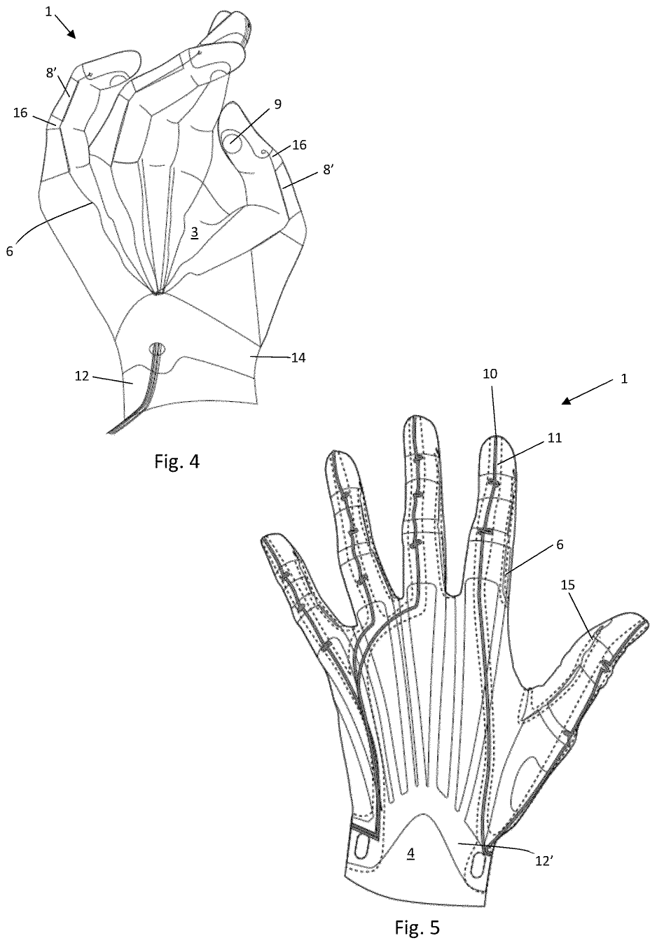

FIG. 3 shows an embodiment of a dorsal side 4 of a knitted glove 1. A hand portion 2 is made of a stretchable material and have at least one reinforced area 8 that is knitted so that it has limited stretch in a direction crosswise the length direction of the finger portion 5. A fingertip 7 of the finger portion 5 is knitted so that it has limited stretch in at least two directions. The reinforced areas 8 having limited stretch in a direction crosswise the length direction of the finger portion are arranged on the dorsal side of the finger portions 5, not encircling the finger portion 5. It is preferred that the reinforced areas 8 reach down on at least one side 16 of the finger portion 5 (as shown in FIG. 4), preferably on both sides 16, creating reinforced side portions 8′. Reinforced areas 8 may be provided at further parts of the knitted glove. The palm side of the finger portion is of a stretchable material.

At least one artificial tendon 6 is arranged at the outside or within the knitted fabric of the knitted glove or in a channel, further described below, running along the length on one side 16 of the finger portion 5 and being attached to the fingertip 7. Preferably, there is one artificial tendon on each side 16 of the finger portion. The artificial tendon 6 is preferably slidably attached at the reinforced areas 8, preferably along the side portion(s) 8′. The artificial tendon 6 may be slidably attached by means of, for example, loops or a tunnel made up with stiches (not shown).

The artificial tendon may 7 instead run along the length on one side 16 of the finger portion, up to the fingertip 7 and down the other side of the finger portion 16. In the latter case, the artificial tendon is preferably slidably attached at the fingertip 7 and the reinforced areas 8, along the side portion(s) 8′. The artificial tendon 6 may be slidably attached by means of, for example, loops or a tunnel made up with stiches (not shown).

Although it is preferred that the limited stretch is a stretch limited in the material itself, accomplished by the knitting, it is also possible to achieve a limited stretch in other ways, such as knitting with a melt yarn, lamination of the yarn with adhesives or heat press on a material that solidifies when it cools down, such as a rubber sheet or silicone sheet or any other suitable material.

FIG. 4 shows an embodiment of a palm side 3 of a glove 1 according to the present invention. In this embodiment the reinforced areas 8 having limited stretch reach down on at least one side 16 of the finger portion, as shown in FIG. 3, preferably on both sides (not shown). Areas having limited stretch 8 may be provided at further parts of the glove 1 too, which will be described below. A wrist portion 12 is provided. The wrist portion may have a limited stretch in at least one direction, preferably in the direction towards the fingers. The wrist portion 12 may be provided with a pocket 14 for a wrist brace. The wrist brace can for example be a band that is rigid but bendable, preferably in an elastic way, in the circumferential direction, i.e. bendable to and from a centre axis of the circumference. In this way it is possible to enlarge the circumference in order to let a hand of a wearer through and then it may spring back to an original shape. In case of no wrist brace present it is preferred to have limited stretch in at least two, orthogonal directions.

It is preferred that the at least one sensor 9 is attached at the fingertip 7, as shown in FIGS. 1 and 3. Obviously, sensors 9 may be arranged at more positions of the knitted grip strengthening glove, for example in the palm of the hand. At least one electrical cable 11 is attached, for example for connection of the at least one sensor 9 with a control means (not shown). The cable 11 can for example be threaded through slits provided in the reinforced areas 8. According to another embodiment, conductive threads are knitted into the material leading up to the sensor 9.

Thus, the knitted grip strengthening glove may sense when a wearer is going to grip some-thing and thus starting the pulling of the at least one artificial tendon 6 in order to enhance the gripping.

FIG. 5 shows an embodiment of a dorsal side of a knitted grip strengthening glove, where the finger portion 5 have been provided with a knitted channel 10 running from the fingertip 7 and along the length of the finger. The knitted channel 10 is used to bring a cable 11 up along the finger portion 5 and attach it to a sensor 9 provided at the fingertip 7. Other knitted channels 15 can also be provided along a side of the finger portion 5, running from the palm, on the palm side 3 of the glove, and up along the finger portion 5. The knitted channel 15 is used to bring a tendon 6 up along the finger portion 5 and attach it at the fingertip 7, as shown in this embodiment.

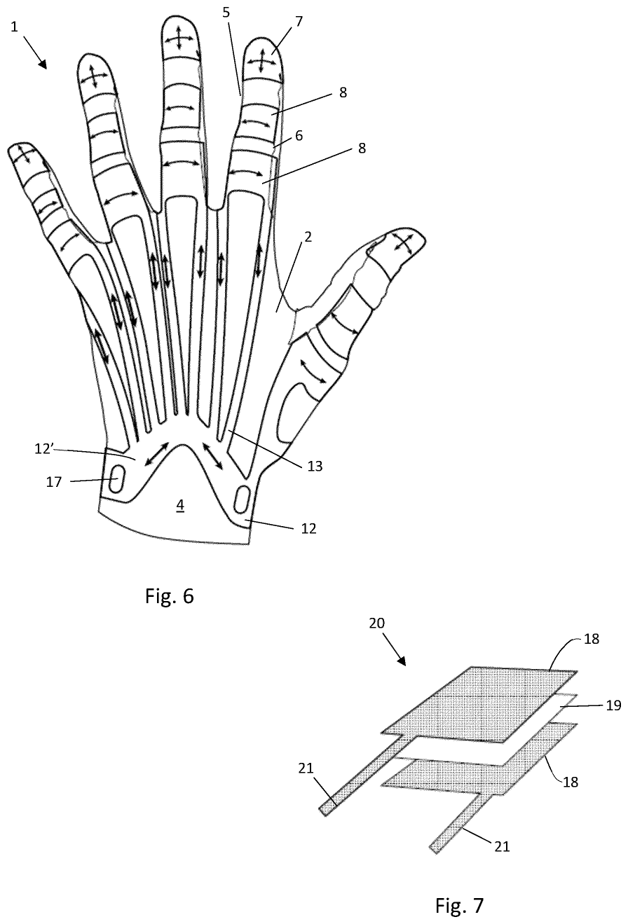

FIG. 6 shows an embodiment of the dorsal side of the knitted grip strengthening glove 1, where arrows have been added to show the directions of limited stretch in different parts of the glove. In FIG. 6 the fingertips 7 are knitted so that there is limited stretch in two directions, two reinforced areas 8 along each finger is knitted so that there is limited stretch in a direction crosswise the length direction of the finger portion 5 and the dorsal portion 4 have lengthwise areas 13 with limited stretch in the length direction of the areas, which areas are extending from the wrist portion 12 up to reinforced areas 8 of the finger portions 5. The lengthwise areas 13 helps the glove not stretch too much along the back of the hand.

As shown in FIGS. 5 and 6 the lengthwise areas 13 from each finger portion 5 run to the wrist portion 12. The wrist portion 12 also function as a force anchoring when the tendons are pulled so that the glove do not glide up over the hand.

The lengthwise areas 13 connect to a v-shaped area 12′ on the dorsal side of the wrist portion 12, which v-shaped area 12′ have a limited stretch, for example in the same direction as the lengthwise areas 13, or lengthwise along the “branches” of the V. Obviously, it is also possible to limit the stretch in also a perpendicular direction to the two previous suggestions. The tip of the V is directed towards the finger portions 5 of the glove 1. The V-shaped area 12′ is provided to ensure that the wrist portion 12 of the glove can be opened sufficiently for the wider part of a hand to be inserted through the wrist portion 12 of the glove 1 by means of the possibility to stretch more or less crosswise to the limited stretch direction, especially as the “branches” of the V may easily stretch apart. The wrist portion 12 may further be provided with two openings 17, in order to be able to attach, for example, a force anchoring device inside the wrist portion 12, or a band, ribbon or string of limited stretch to be closed after a user's hand is put in the glove. It is also conceivable to attach a band, ribbon or string to the ends of the “branches” to be able to keep the branches together and avoid that the glove glides up over the hand of the wearer.

The wrist portion 12 can further be provided with a guiding (not shown) which guides the artificial tendons 6 towards an actuator (not shown) for example arranged at a wrist portion 12 of the knitted grip strengthening glove 1. The actuator can pull the artificial tendons 6 when being given a signal. The signal may be achieved from at least one sensor 9 arranged in the knitted grip strengthening glove 1.

During the knitting process, it is also possible to create a pressure or force sensor. Such a knitted sensor would be fully integrated into the knitted fabric, enabling a seamless and efficient production process. See FIG. 7 for a general overview of a knitted sensor 20. One embodiment of such sensor 20 consists of conductive threads or yarns knitted to form two layers 18, e.g. in a serpentine or mesh pattern, making up a sensor area. Between the two conductive layers 18, a semi-conductive material 19 that changes its electrical properties when force is applied is positioned. This material 19 could be a knitted structure, but also an external material that is inlayed during or after the knitting process. Examples of possible semi-conductive materials changing properties when force is applied are piezoelectric, resistive and capacitive materials.

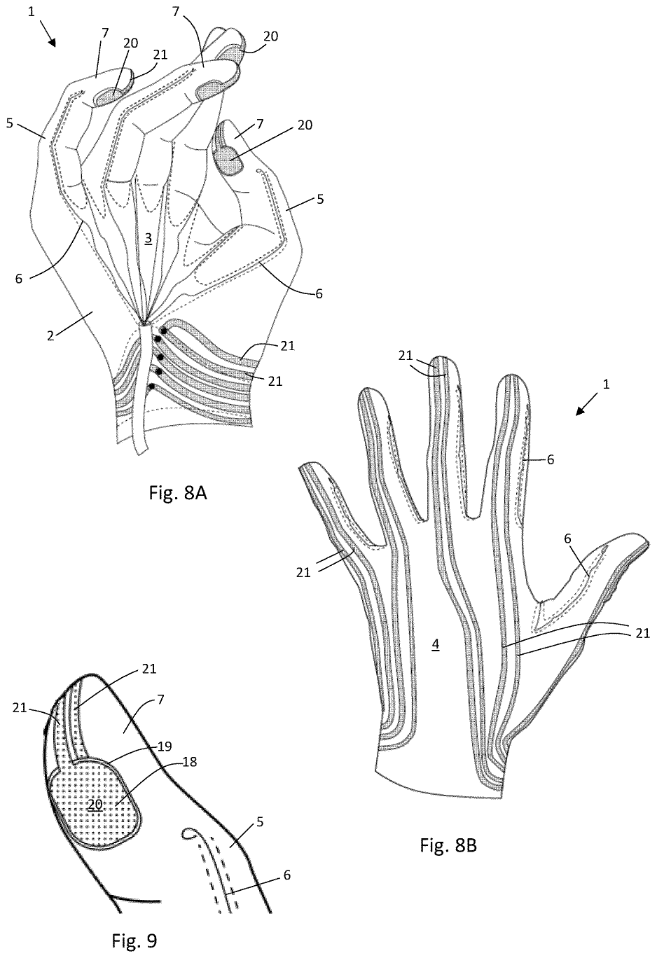

In FIG. 8A and B a grip enhancing glove is shown which may comprise any of the features described above, especially reinforced areas 8 and lengthwise areas 13, but for clarity reasons those features are not shown in FIG. 8A and B. In this embodiment, a knitted sensor 20 is provided on at least one fingertip 7 of a finger portion 5. A conductive 18 and a semi-conductive 19 material are positioned in a desired area of the glove 1 and may have a physical distribution that matches the sensor area 20, see FIG. 9. A load or pressure applied to the sensor 20 will cause a detectable change of its electrical characteristics. When measured, any such change correlates to a change in pressure or a specific force value.

Another embodiment of a knitted pressure or force sensor comprises conductive thread(s) alone, which has a resistance that varies with its elongation. The thread(s) could be knitted in several patterns including but not limited to straight lines and serpentine patterns. That means, when load or pressure is applied to the sensor the thread stretches with in-creased electrical resistance as a consequence. A load or pressure applied to the sensor will cause a detectable change of its electrical resistance. When measured, any such change correlates to a change in pressure or a specific force value.

In any of the abovementioned embodiments, the conductive threads may continue along a conductive area 21 of the finger portion 5 and further over the hand portion 2 to provide connection to a Printed Circuit Board or other electronic components (not shown). It is also conceivable to use cables 11 to connect the knitted sensor(s) 20. A user interface could be provided as one or more electric components in a pocket or knitted in conductive and semiconductive threads making up user interface, for example at the wrist portion 12 or the dorsal side 4 of the hand portion 2.

Any of the embodiments described herein can further be provided with threads providing cutting protection or threads providing fire protection, which threads are knitted into the glove. The threads can also be conductive threads leading up to the sensor provided at the fingertip.

In some applications, a knitted grip strengthening glove according to any of the embodiments described above may be used as a liner in a glove. The glove will serve as a protecting layer on top of the knitted grip strengthening glove. This may be advantageous if the knitted glove is to be used in an environment where the knitted glove may be damaged in any way. A protective glove could also be used on top of the knitted grip strengthening glove to add characteristic properties such as cutting protection or fire protection.

In the present application the embodiments show a knitted grip strengthening glove for all fingers, including the thumb. Although not shown explicitly herein, it is possible to provide a knitted grip strengthening glove having all fingers and strengthening arrangement for all fingers, or only one finger, or the thumb and the index finger, or the thumb and the two middle fingers, or in any other combination.

A knitted glove according to the present invention requires little or no manual labor to produce. When the design program is defined according to what has been described herein, machine parameters set, and yarns specified and prepared, the running cost will be related to yarn consumption and machine time. The quality of the outcome will be uniform, and the textile waste will be reduced to a minimum. This means the production method reduces costs related to manual labor, quality non-conformities, and environmental costs related to textile waste.

A knitted force strengthening glove as described herein would give advantages, as compared to a sewn grip strengthening glove, in quality, efficiency, production economy, ecology, flexibility as well as user comfort.

1. A knitted grip strengthening glove comprising a hand portion having a palm side and a dorsal side and at least one finger portion,
wherein the knitted grip strengthening glove is knitted into a stretchable material wherein at least one artificial tendon is arranged at the outside or within the knitted material of the knitted glove,
wherein the at least one finger portion is knitted so that at least one fingertip of the glove has limited stretch;
wherein the at least one finger portion is knitted so that it comprises at least one reinforced area with limited stretch in a direction crosswise the length direction of the at least one finger portion on the dorsal side of the glove, while the palm side of the finger portion and the glove is a knitted structure that is flexible in at least two directions, the reinforced areas reach down on each side of the finger portion creating reinforced side portions, wherein the at least one artificial tendon is slidably attached at the reinforced side portions,
wherein the dorsal side of the hand portion comprises lengthwise areas extending from a wrist portion up to the at least one finger portion, which lengthwise areas have limited stretch in the length direction.

2. The knitted grip strengthening glove according to claim 1, wherein the at least one finger portion comprises at least one knitted channel provided along the finger portion for a cable and which cable is attached to a sensor provided at the fingertip.

3. The knitted grip strengthening glove according to claim 1, wherein the at least one finger portion comprises at least one knitted channel along a side portion of the finger portion for an artificial tendon, which artificial tendon is attached to or pass at the fingertip.

4. The knitted grip strengthening glove according to claim 1, wherein the at least one finger portion comprises conductive threads leading up to a sensor provided at the fingertip.

5. The knitted grip strengthening glove according to claim 1, wherein the lengthwise areas connect to a v-shaped area on the wrist portion on the dorsal side of the knitted grip strengthening glove, which v-shaped area have a limited stretch.

6. The knitted grip strengthening glove according to claim 1, wherein the sensor provided on at least one fingertip of the glove is a knitted sensor.

7. The knitted grip strengthening glove according to claim 1, wherein the wrist portion is provided with at least one opening in order to be able to attach a force anchoring device or a band, ribbon or string of limited stretch inside wrist portion.

8. The knitted grip strengthening glove according to claim 1,
wherein the at least one finger portion is provided with at least two reinforced areas having limited stretch in a direction crosswise the length direction of the finger portion on the dorsal side of the finger portion.

9. The knitted grip strengthening glove according to claim 1, wherein threads providing cutting protection or threads providing fire protection are knitted into the glove.

10. A glove comprising a knitted grip strengthening glove according to claim 1, as a liner.
